(19) United States
(12) Patent Application Publication
(10) Pub. No.: US 2007/0282996 A1
(43) Pub. Date: Dec. 6, 2007

(54) Network connection apparatus and providing service control program

(75) Inventors: Hiroyuki Chaki, Ome-shi (JP); Hideki Ohkita, Kunitachi-shi (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHIKI KAISHA TOSHIBA, Tokyo (JP)

(21) Appl. No.: 11/806,408

(22) Filed: May 31, 2007

(30) Foreign Application Priority Data
May 31, 2006 (JP) 2006-152719

(51) Int. Cl. G06F 15/173

(52) U.S. Cl. 709/223

(57) ABSTRACT

According to one embodiment, a network connection apparatus includes a network connection unit connected to a network and configured to detect a change in a network, a registering unit configured to store identification data obtained from a partner apparatus via the network, and to register the partner apparatus, a collecting unit configured to collect the identification data of the partner apparatus via the change-detected network based on change detection of the network, and a service providing unit configured to compare identification data of a registered partner apparatus and the collected identification data, to determine whether the partner apparatus connected via the change-detected network is registered or unregistered, and to differentially provide a service to the registered partner apparatus and a service to the unregistered partner apparatus.

### CROSS-REFERENCE TO RELATED APPLICATIONS

This application is based upon and claims the benefit of priority from Japanese Patent Application No. 2006-152719, filed May 31, 2006, the entire contents of which are incorporated herein by reference.

### BACKGROUND

1. Field

One embodiment of the invention relates to a network connection apparatus such as a computer which is connected to a network and can provide various services to an apparatus connected to the network. Another embodiment of the invention relates to a providing service control program which is applied to the network connection apparatus to control the service to be provided from the network connection apparatus.

2. Description of the Related Art

UPnP (Universal Plug and Play) is a standard which mainly defines a protocol for the server and client apparatuses in an IP network for, e.g., discovering an apparatus and remotely controlling the server apparatus. In UPnP, connectivity poses a problem. To cope with this problem, the DLNA (Digital Living Network Alliance) provides a guideline for defining the restriction factors of UPnP, and the specification of a physical layer and the like. Specifically, the DLNA guideline is premised on a use scene in which the client apparatus and the server apparatus which publishes audio contents and video contents including moving and still images are used at home. The server and client apparatuses based on the DLNA guideline are commercially available now as one function of a PC, DVD recorder, and DTV.

For example, Jpn. Pat. Appln. KOKAI Publication No. 2005-117631 proposes a method of forming a unique domain to allow only an authorized user to use the contents in a home network based on UPnP. This method can prevent a third party from illegally using the contents.

Although the UPnP standard and the DLNA guideline secure connectivity, a service may be undesirably provided to an unintentional apparatus when directly using these standard and guideline in a network other than the home network. In other words, the server apparatus (notebook PC, portable apparatus, or the like) having a content publication function may breach user's privacy when moving between networks. On the other hand, if the function stops, high convenience of the UPnP standard and DLNA guideline cannot be obtained. Also, the same problems arise when a guest brings a portable apparatus into one's home.

The UPnP standard and DLNA guideline do not define a method of notifying remaining apparatuses of the presences and functions of a client apparatus and an apparatus which only controls the server apparatus. Hence, the server apparatus cannot know whether there is a client apparatus in a destination network.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a view showing the use example of network connection apparatuses (server and client apparatuses) according to an embodiment of the invention;

FIG. 2 is a block diagram showing an outline of the arrangement of a network connection apparatus according to the embodiment of the invention;

FIG. 3 is a flowchart for explaining a providing service limitation process performed by the network connection apparatus (server apparatus) according to the embodiment;

FIG. 4 is a view showing an example of an apparatus registration form according to the embodiment; and

FIG. 5 is a flowchart for explaining the providing service limitation process performed by the network connection apparatus (client apparatus) according to the embodiment.

### DETAILED DESCRIPTION

Various embodiments according to the invention will be described hereinafter with reference to the accompanying drawings. In general, according to one embodiment of the invention, a network connection apparatus includes a network connection unit connected to a network and configured to detect a change in a network, a registering unit configured to store identification data obtained from a partner apparatus via the network, and to register the partner apparatus, a collecting unit configured to collect the identification data of the partner apparatus via the change-detected network based on change detection of the network, and a service providing unit configured to compare identification data of a registered partner apparatus and the collected identification data, to determine whether the partner apparatus connected via the change-detected network is registered or unregistered, and to differentially provide a service to the registered partner apparatus and a service to the unregistered partner apparatus.

An embodiment of the present invention will be described below with reference to the accompanying drawing.

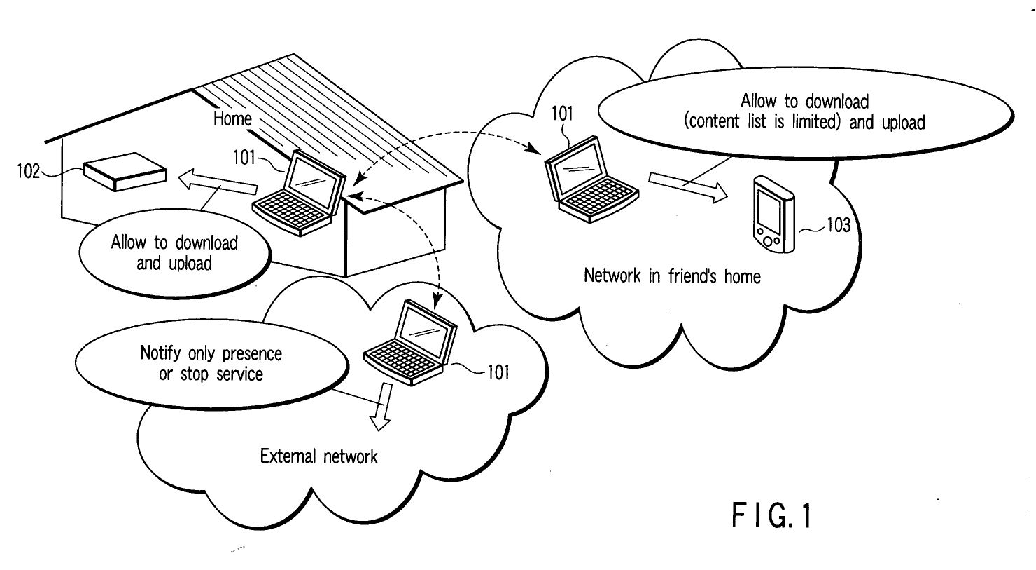

FIG. 1 is a view showing the use example of network connection apparatuses (server and client apparatuses) according to this embodiment. Referring to FIG. 1, an apparatus 101 is the server apparatus which stores contents such as still images, music, and moving images, and has a function of publishing these contents to another apparatus (the client apparatus such as an apparatus 102 or 103) connected to a network. The apparatus 101 is a movable server apparatus such as a notebook PC or portable apparatus, and can be connected to the apparatus 102 in the first network or to the apparatus 103 in the second network.

In accordance with each condition, the apparatus 101 provides/acquires a video content and the like to/from the apparatus 102 or 103 to play back/record them.

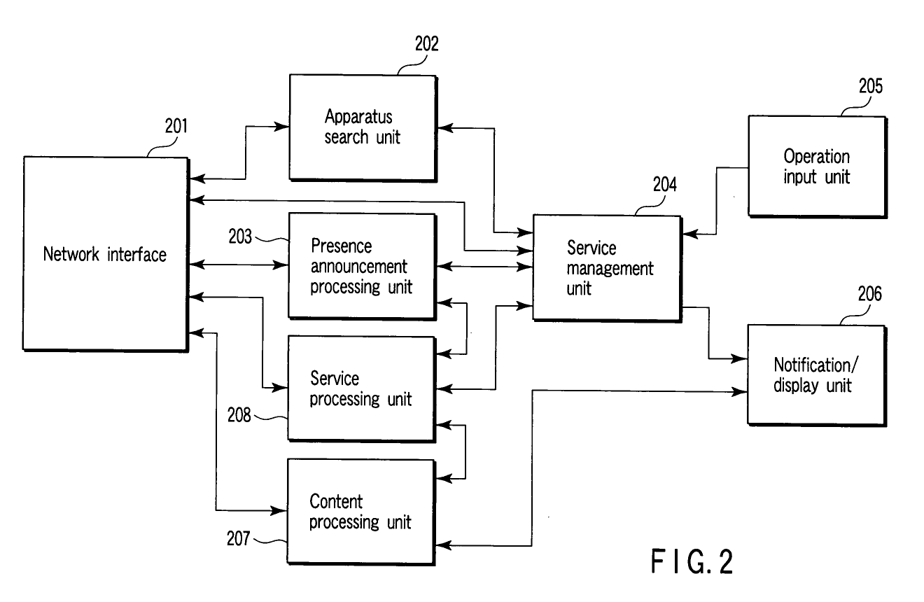

FIG. 2 is a block diagram showing an outline of the arrangement of the network connection apparatus (apparatus 101) according to this embodiment.

The apparatus 101 includes a network interface 201, apparatus search unit 202, presence announcement processing unit 203, service management unit 204, operation input unit 205, notification/display unit 206, content processing unit 207, and service processing unit 208.

The presence announcement processing unit 203 broadcasts the presence of the self apparatus (apparatus 101) to many unspecified partner apparatuses connected via the network interface 201. In this case, the presence announcement processing unit 203 announces it to the many unspecified apparatuses in a state wherein the service (function and content) of the self apparatus is not published. On the other hand, the presence announcement processing unit 203 individually announces the presence of the self apparatus to a specified partner apparatus (registered partner apparatus). In this case, the presence announcement processing unit 203 announces it to the specified partner apparatus (registered partner apparatus) in a state wherein a predetermined service (function and content) of the self apparatus is published. The apparatus search unit 202 collects the presence announcements of the partner apparatuses to acquire the unique information (identification information) of the partner apparatuses on the network.

The content processing unit 207 transmits the content in a recording apparatus such as an HDD to the partner apparatus via the network interface 201, and, in return, transmits the content from the partner apparatus to the recording apparatus via the network interface 201. The service processing unit 208 provides a service for publishing a content list used by the content processing unit 207 and securing logical connectivity on a transmission path, and simultaneously acquires the unique information of the apparatuses which access the service. The service management unit 204 confirms a registered apparatus by using the apparatus search unit 202 and presence announcement processing unit 203 to limit the service provided from the service processing unit 208.

For example, the notification/display unit 206 displays the apparatus on the network for a user. The operation input unit 205 receives a user's input to select the registered apparatus.

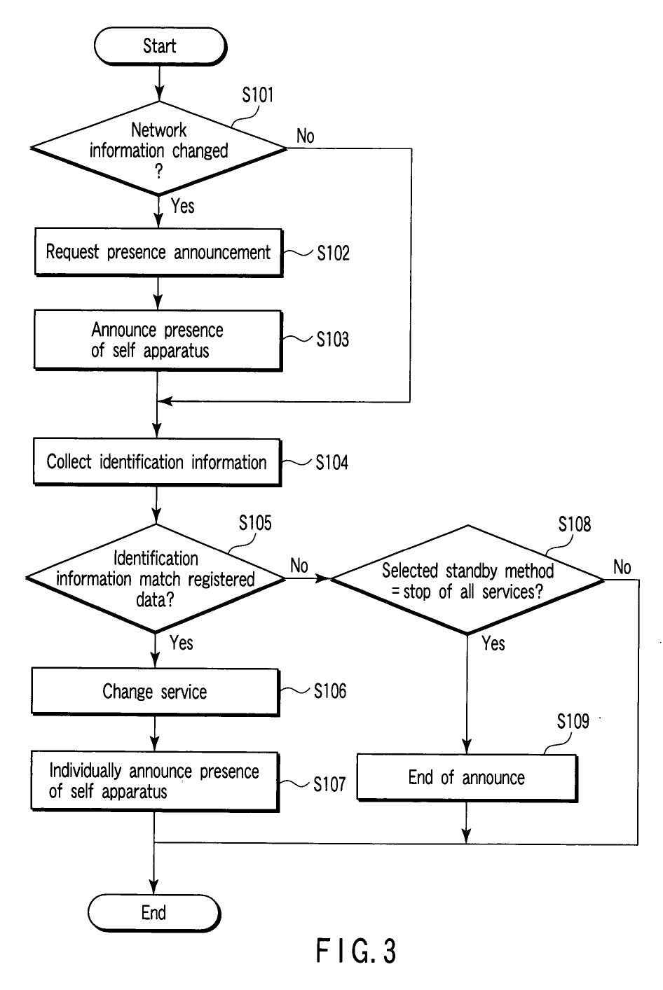

The operation of the apparatus 101, especially, the process of the service management unit 204 will be described next with reference to the flowchart shown in FIG. 3.

The process starts in response to change detection of network information, or packet reception associated with the presence announcement from the partner apparatus, as a trigger. That is, the process changes depending on whether the network information is updated, e.g., whether the address of the network interface 201 changes, whether a transmission medium such as a cable is disconnected or switched, or whether a DHCP (Dynamic Host Configuration Protocol) server is switched (S101).

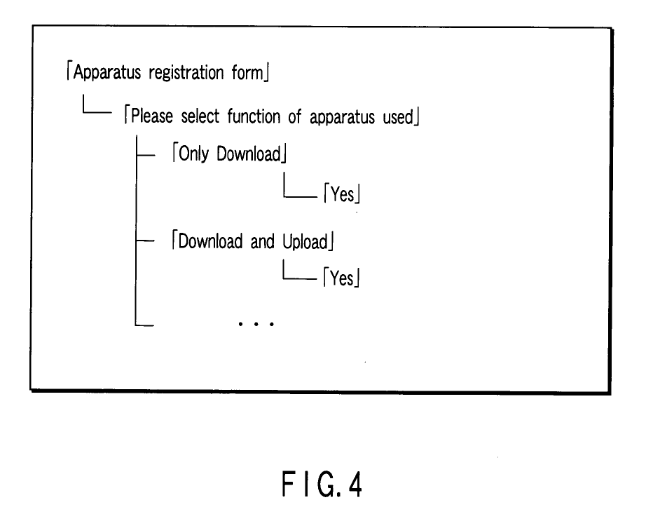

When the network information is updated (YES in S101), the service management unit 204 minimizes the service to be provided from the service processing unit 208. The minimum service means a service for starting a CDS (Content Directory Service) for an empty content list different from the actual content list, and a list to check the function of the connection apparatus as shown in FIG. 4.

In UPnP, the service management unit 204 searches the partner apparatus on the network to notify it of the presence of the self apparatus by a method called an SSDP (Simple Service Discovery Protocol). Immediately upon connection to the network or upon reception of a request called M-SEARCH, the service management unit 204 broadcasts, as a UDP (User Datagram Protocol) packet, information such as a URI (Uniform Resource Identifier) representing the address of providing service digest information, and an apparatus-unique ID (identifier) called a UUID in a text format.

In order to check the presence of the server apparatus on the network, the apparatus search unit 202 broadcasts the M-SEARCH request as the UDP packet to request the presence announcement (S102). At the same time, the presence announcement processing unit 203 announces the presence of the self apparatus by using its UUID together with the content of the service processing unit 208 (this operation is called advertisement in the SSDP) (S103). With this operation, when an apparatus (the client apparatus or an apparatus which only controls the server) other than the server is present on the network, this apparatus other than the server accesses the service processing unit 208. That is, the client apparatus accesses the service processing unit 208 in response to the presence announcement (dummy presence announcement) of the self apparatus.

The apparatus search unit 202 collects, as the identification information, the UUIDs and MAC (Media Access Control) addresses of the apparatus other than the server which accesses the service processing unit 208, and the server apparatus which announces its presence in response to the request issued in S102 (S104). When the presence announcement processing unit 203 announces the presence of the self apparatus upon setting TTL (Time To Live) to 1, the MAC addresses can be collected without using a router.

The apparatus search unit 202 confirms whether an apparatus which matches the collected UUID and MAC address is present in a profile registered in advance, and then determines a service to be provided (S105). That is, the apparatus search unit 202 determines whether the partner apparatus is registered or unregistered, and then differentially provides services to the registered and unregistered partner apparatuses. More specifically, the service to be provided to the unregistered partner apparatus is limited in comparison with that to be provided to the registered partner apparatus.

When the user selects the apparatus on the network, and simultaneously determines a providable service content, the above-described profile is generated in advance. The service management unit 204 stores this profile.

In order to play back the content of a given server apparatus, the client apparatus generally displays a list of server apparatuses to prompt the user to select a predetermined server apparatus from this server apparatus list. After that, the client apparatus displays the content list of the selected server apparatus. Since the content list is hierarchized, the user must select folders a plurality of times to select a target content.

For example, the apparatus 101 provides the content list as shown in FIG. 4 to prompt the user to select the content corresponding to the function. With this operation, the apparatus 101 can also acquire the function of the apparatus other than the server. When registering information from the presence announcement and the apparatus other than the server, the server apparatus causes the registered apparatus to report its function in the above method. The apparatus 101 stores the service content as a profile such as a use method or a use environment, e.g., home, friend's home, or outside, while associating the service provided to the target apparatus, the moving direction of the content, and the published contents with the collected UUID and MAC address. In addition to the DLNA apparatus, the apparatus 101 can associate the DHCP server or wireless apparatus with a device such as an access point.

The apparatus 101 once performs end notification called “ByeBye” in accordance with the SSDP in correspondence with the service, UUID, and the like notified in S101. Hence, the apparatus 101 can declare that the self apparatus is disconnected from the network, and stop the notified service. After that, the service provided from the service processing unit 208 changes (S106).

After that, the apparatus 101 announces its presence in accordance with a new service content (a service which matches the registered partner apparatus). In S103, the apparatus 101 broadcasts its presence. However, in this case, the apparatus 101 does not broadcast its presence, but announces it only to the apparatus (registered partner apparatus) specified in S105. That is, the apparatus 101 individually transmits its presence announcement to the apparatus specified in S105 (S107).

In a series of these processes, the unregistered apparatus in the network does not confirm the presence of the self apparatus. This can prevent unregistered apparatuses in the network from accidentally accessing the self apparatus. Additionally, a filtering process with the MAC address can prevent any unauthorized apparatus from accessing.

If the partner apparatus matches none of the profiles (if the partner apparatus is unregistered) in S105, or if it is determined that the partner apparatus belongs to an external network, the operation content is determined in accordance with the standby method selected by the user in advance (S108). For example, when all services to the external network are stopped in a standby state, the end announcement described in S106 is performed (S109).

As described above, the service to be provided is limited whenever the network information changes. This can prevent an unregistered apparatus from accidentally accessing the content list to protect user's privacy without any user's switching operation even when the apparatus 101 moves between the networks.

This embodiment will be summarized below.

This embodiment protects user's privacy without losing convenience when a server (notebook PC, portable apparatus, or the like) having a content publication function moves between networks.

(1) A server changes its service to be published based on movement between the networks. That is, the server changes its function and content to be published included in the functions and contents of the self apparatus. More specifically, a function of downloading and uploading, and the published content list are exemplified.

(2) The server apparatus determines whether a partner apparatus is registered or unregistered, and differentially provides services to the registered and unregistered partner apparatuses. More specifically, the server apparatus limits the service to be provided to the unregistered partner apparatus in comparison with that to be provided to the registered partner apparatus.

(3) Partner Apparatus Discovering (Network Determination) Method

(a) Partner Apparatus Search (started when the IP address or the like changes)

Advertise minimum service (dummy (the window shown in FIG. 4))

Collect the MAC addresses of the partner apparatuses (DMPs) which accesses the server apparatus

Perform M-Search, or collect the UUIDs based on advertisement from the partner apparatuses (DMSs)

(b) The server apparatus confirms whether the collected UUID or MAC address is registered, and determines whether the partner apparatus is registered or unregistered to switch the service to be provided.

(c) The server apparatus once performs “ByeBye” if in the dummy mode, and performs advertisement again only for the specified (registered) partner apparatus.

The server apparatus provides all services to the first-level registered apparatus (an apparatus in home).

The server apparatus provides only some of the services to the second-level registered apparatus (a friend's apparatus).

Note that upon reception of M-Search from another apparatus after determination, the server apparatus acquires the MAC address, and starts from (b).

(4) Apparatus Registration

In order to register the DMP or CP, the server apparatus causes the partner apparatus to report its function from the content list. The user selects the apparatus on the network, and simultaneously determines a providable service content. The service content is stored in association with the collected UUID and MAC address.

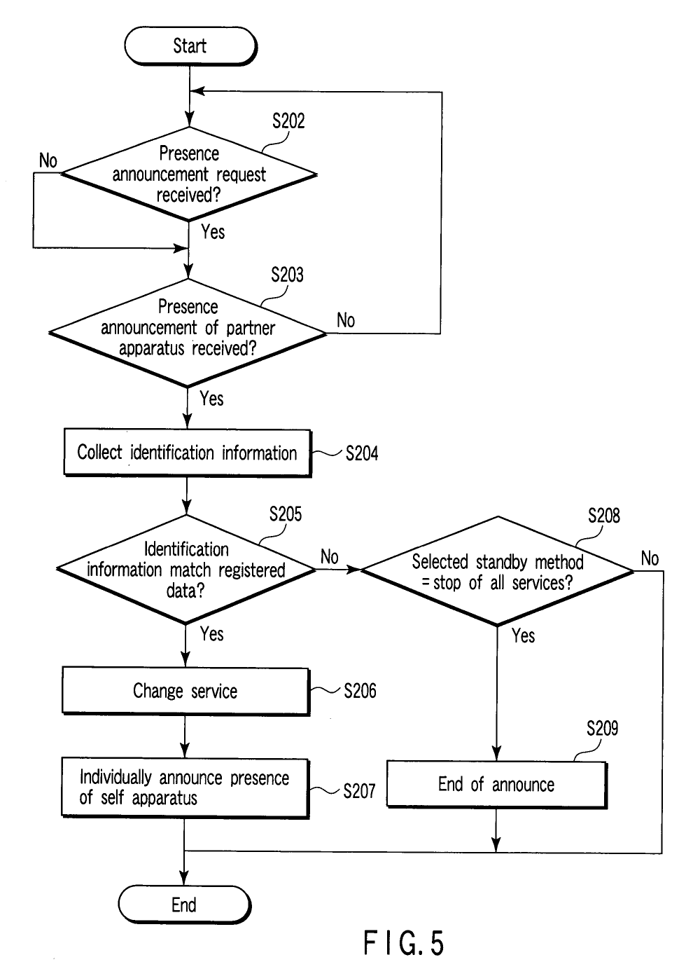

As described above, the apparatus 101 (the apparatus which is movable between networks) limits the service to be provided. However, the present invention is not limited to this. For example, the present invention can be applied to the apparatus 102 or 103 (the apparatus which is not movable between networks) which already belongs to the network in question. The basic arrangement of the apparatus 102 or 103 is the same as that of the apparatus 101 (see FIG. 2). The process sequence in this case will be described below with reference to FIG. 5.

As described above, the operation of the apparatus 101 starts in response to a change in network, as a trigger. On the other hand, the operation of the apparatus 102 or 103 starts in response to at least one of reception (S202) of a presence announcement request (S102) and reception (S203) of a presence announcement (S103), as a trigger.

After that, an apparatus search unit 202 of the apparatus 102 or 103 collects the identification information from the partner apparatus (S204), and a service management unit 204 of the apparatus 102 or 103 determines whether the partner apparatus is registered or unregistered (S205) to switch the services to be provided to the registered and unregistered partner apparatuses (S206 and S208). A presence announcement processing unit 203 of the apparatus 102 or 103 individually announces the presence of the self apparatus to the registered partner apparatus (S207), and sends an end notification to the unregistered partner apparatus (S209).

While a certain embodiment of the inventions has been described, this embodiment has been presented by way of example only, and is not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A network connection apparatus comprising:
a network connection unit connected to a network and configured to detect a change in a network;
a registering unit configured to store identification data obtained from a partner apparatus via the network, and to register the partner apparatus;
a collecting unit configured to collect the identification data of the partner apparatus via the change-detected network based on change detection of the network; and
a service providing unit configured to compare identification data of a registered partner apparatus and the collected identification data, to determine whether the partner apparatus connected via the change-detected network is registered or unregistered, and to differentially provide a service to the registered partner apparatus and a service to the unregistered partner apparatus.

2. An apparatus according to claim 1, which further comprises a presence announcement request unit configured to request a presence announcement for the partner apparatus via the change-detected network based on change detection of the network, and in which the collection unit collects the identification data of the partner apparatus based on at least one of a response from the partner apparatus to the presence announcement request, and a service request from the partner apparatus.

3. An apparatus according to claim 1, further comprising a presence announcement unit configured to broadcast, based on change detection of the network, a presence announcement of a self apparatus to many unspecified partner apparatuses connected to the change-detected network, and to individually transmit, based on a determination result of the registered apparatus, the presence announcement of the self apparatus to the registered partner apparatus connected to the change-detected network.

4. An apparatus according to claim 3, wherein the presence announcement unit announces the presence of the self apparatus in a state in which a service is not published to the many unspecified partner apparatuses connected to the change-detected network, and announces the presence the presence of the self apparatus in a state in which a predetermined service is published to the registered partner apparatus connected to the change-detected network.

5. An apparatus according to claim 1, wherein the service providing unit limits the service to be provided to the unregistered partner apparatus in comparison with the service to be provided to the registered partner apparatus.

6. A network connection apparatus comprising:
a network connection unit configured to be connected to a network;
a registering unit configured to store identification data obtained from a partner apparatus via the network, and to register the partner apparatus;
a collecting unit configured to collect the identification data from the partner apparatus via the network based on at least one of a presence announcement request transmitted from the partner apparatus via the network, and a presence announcement transmitted from the partner apparatus via the network; and
a service providing unit configured to compare identification data of a registered partner apparatus and the collected identification data, to determine whether the partner apparatus connected via the network is registered or unregistered, and to differentially provide a service to the registered partner apparatus and a service to the unregistered partner apparatus.

7. An apparatus according to claim 6, wherein the service providing unit limits the service to be provided to the unregistered partner apparatus in comparison with the service to be provided to the registered partner apparatus.

8. A providing service control program comprising:
a procedure of collecting identification data of a partner apparatus via a change-detected network based on change detection of the network; and
a procedure of comparing identification data of a registered partner apparatus and the collected identification data, determining whether the partner apparatus connected via the change-detected network is registered or unregistered, and differentially providing a service to the registered partner apparatus and a service to the unregistered partner apparatus.

9. A program according to claim 8, further comprising a procedure of storing the identification data obtained from the partner apparatus via the network, and registering the partner apparatus.

10. A program according to claim 8, further comprising a procedure of requesting a presence announcement for the partner apparatus via the change-detected network based on change detection of the network, and collecting the identification data of the partner apparatus based on at least one of a response from the partner apparatus to the presence announcement request, and a service request from the partner apparatus.

11. A program according to claim 8, further comprising a procedure of broadcasting, based on change detection of the network, a presence announcement of a self apparatus to many unspecified partner apparatuses connected to the change-detected network, and to individually transmit, based on a determination result of the registered apparatus, the presence announcement of the self apparatus to the registered partner apparatus connected to the change-detected network.

12. A program according to claim 11, further comprising a procedure of announcing the presence of the self apparatus in a state in which a service is not published to the many unspecified partner apparatuses connected to the change-detected network, and announcing the presence the presence of the self apparatus in a state in which a predetermined service is published to the registered partner apparatus connected to the change-detected network.

13. A program according to claim 8, further comprising a procedure of limiting the service to be provided to the unregistered partner apparatus in comparison with the service to be provided to the registered partner apparatus.
